(19) United States
(12) Patent Application Publication
(10) Pub. No.: US 2012/0067875 A1
(43) Pub. Date: Mar. 22, 2012

(54) Modular Container Set

(76) Inventor: Yan-Hong Chiang, Taipei (TW)

(21) Appl. No.: 12/886,570

(22) Filed: Sep. 21, 2010

(51) Int. Cl. B65D 6/00; F25B 21/00; H05B 1/02; A47J 31/54

(52) U.S. Cl. 220/4.27; 392/441; 62/3.1; 219/492

(57) ABSTRACT

A modular container set is provided. The modular container set includes a first container, a second container, and a temperature unit. The first container includes a lid. The lid is configured with a drinking unit. An upper portion of the second container is adapted for being assembled to a bottom portion of the first container. The temperature unit is adapted for assembled to a bottom portion of the second container, and is adapted for heating or cooling the second container, or maintaining the second container warm or cool.

### BACKGROUND OF THE INVENTION

1. Field of the Invention

The present invention relates generally to a modular container set, and more particularly to a container device adapted for fast serving a beverage.

2. The Prior Arts

Many kinds of beverages require very complicated procedures and appliances for serving. In some circumstances, the solid substance of the beverage is desired to be separated from water, and the serving operation is often required to be conducted under a specific temperature. In addition, the subsequent brewing and flushing operations are still complicated.

For example, when a mother intends to reconstitute powdered milk for a baby, she should mix cold water with hot water in a certain proportion to obtain a suitable temperature, and then add a certain amount of powdered milk to reconstitute the powdered milk in the water. This requires her to prepare a lot of related items including a feeding bottle, a water heater (or a vacuum flask), a powdered milk jar, or other containers. Some of these items are inconvenient to clean, and the water heater or vacuum flask is usually too large to carry. The mother may even worry about that the hot water might spill out from the water heater or vacuum flask and hurt the baby.

### SUMMARY OF THE INVENTION

Accordingly, a primary objective of the present invention is to provide a modular container set. The modular container set is constituted of a plurality of modular containers prepared with specific specifications. The modular containers are adapted to be assembled into a set, and each of which is adapted for performing individual functions.

For achieving the foregoing objective, the present invention provides a modular container set.

The modular container set includes a first container, a second container, and a temperature unit. The first container includes a lid. The lid is configured with a drinking unit. An upper portion of the second container is adapted for being assembled to a bottom portion of the first container. The temperature unit is adapted for assembled to a bottom portion of the second container, and is adapted for heating or cooling the second container, or maintaining the second container warm or cool.

The first container and the second container are communicable. The modular container set further includes a baffle valve provided between the first container and the second container.

Supposing that a solid substance is to be reconstituted into a beverage by solving in water, and in use, the solid substance and the water can be separately contained in the first container and the second container in advance respectively, in which the solid substance is positioned on the baffle valve. When the user needs to serve the beverage, the baffle valve is turned open such that the solid substance falls down to the water contained in the second container, and is solved thereby.

Alternatively, prior to turning open the baffle valve, the user may select to use the temperature unit to heat or cool the water contained in the second container, so as to obtain a hot or cold beverage as desired.

Comparing with the conventional appliance, the modular container set is simple and convenient for serving a beverage.

According to an embodiment of the present invention, the modular container set further includes a sieve. The sieve is provided in the first container, the second container, or between the first container and the second container. The modular container set of this embodiment is particularly adapted for serving a tea beverage. When the user intends to serve the tea beverage, the temperature unit is used to heat the water contained in the second container to a predetermined temperature. Then, the first container and the second container are placed upside down, so that the hot water is mixed with the tea leave to serve the tea beverage. When the user drinks the tea beverage, the tea leave are stopped by the sieve so that the user won't swallow the tea leave with the tea beverage. After drinking, dregs of the tea leave reside on the sieve, and are convenient for cleaning. Further, in use, the user may directly place the body of the modular container set upside down to allow the water flowing through the sieve to enter the first container, and after a certain moment, then turn the body of the modular container set back to allow the water flowing back to the second container. In such a way, the time of serving the tea beverage can be controlled, so that the tea leave won't be served too long to obtain a tea beverage with a suitable tea concentration.

### BRIEF DESCRIPTION OF THE DRAWINGS

The present invention will be apparent to those skilled in the art by reading the following detailed description of preferred embodiments thereof, with reference to the attached drawings, in which:

FIG. 1 is an exploded perspective view of a modular container set according to an embodiment of the present invention;

FIG. 2 is an exploded view of the modular container set according to an embodiment of the present invention;

FIG. 3 illustrates a modular container set according to another embodiment of the present invention;

FIG. 4 illustrates a modular container set according to a further embodiment of the present invention; and

FIG. 5 illustrates the operation of the modular container set according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

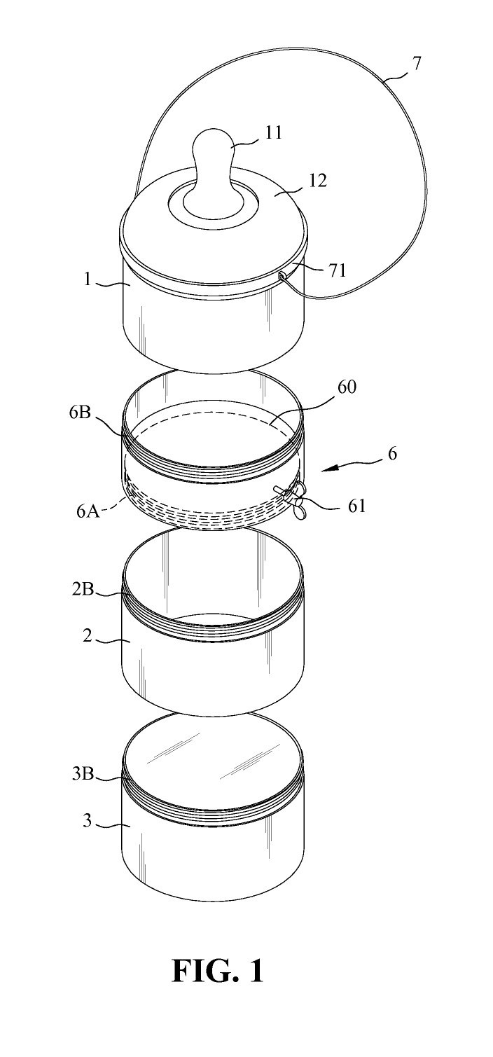

FIG. 1 is an exploded perspective view of a modular container set according to an embodiment of the present invention. Referring to FIG. 1, the modular container set includes a first container 1, a second container 2, a temperature unit 3, and a baffle valve 6. The first container 1 includes a lid 12. The lid is configured with drinking unit 11. The drinking unit for example can be a spout, a nipple unit or a straw (now shown in the drawings). An upper portion of the second container 2 is adapted for being assembled to a bottom portion of the first container 1 so that the first container 1 and the second container 2 are coupled to get communicated. The temperature unit 3 is adapted for assembled to a bottom portion of the second container 2, and is adapted for heating or cooling the second container 2, or maintaining the second container 2 warm or cool.

The baffle valve 6 is provided between the first container 1 and the second container 2. As shown in FIG. 1, the baffle valve 6 includes a butterfly valve plate 60 and a knob 61. When the knob 61 is rotated clockwise or counterclockwise, the butterfly valve plate 60 is turned open or close. Alternatively, the baffle valve 6 can also be constituted of a knob 61 and a valve ball (not shown in the drawings).

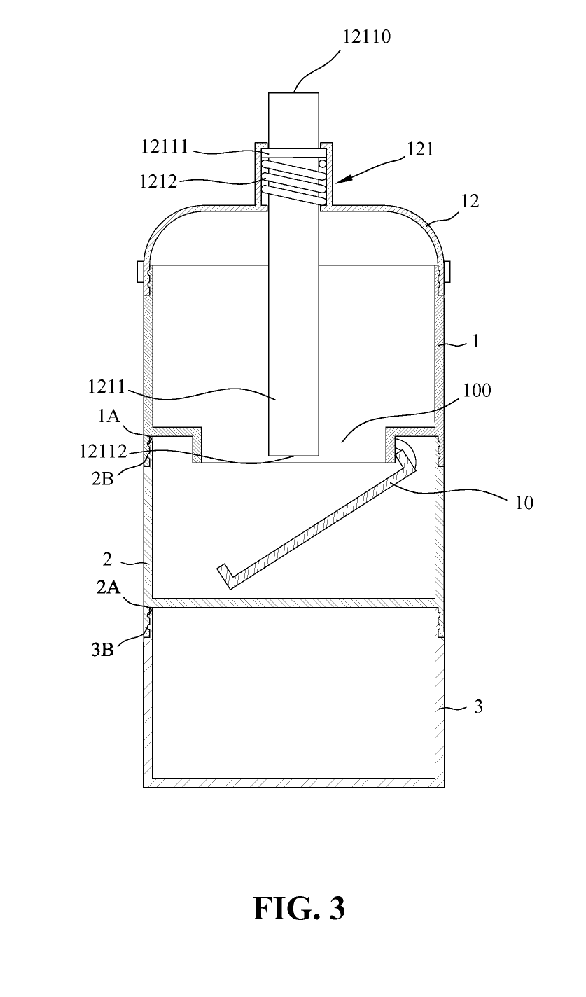

Referring to FIG. 1, a bottom portion of the first container 1 is configured with a first thread 1A (see FIG. 3), a bottom portion of the second container 2 is configured with a thread 2A (see FIG. 3), and a bottom portion of the baffle valve 6 is configured with a first thread 6A. Further, an upper portion of the second container 2 is configured with a second thread 2B, an upper portion of the temperature unit 3 is configured with a second thread 3B, and an upper portion of the baffle valve 6 is configured with a second thread 6B. The first thread 1A of the first container 1 is adapted for threadly assembling with the second thread 6B of the baffle valve 6. The first thread 6A of the baffle valve 6 is adapted for threadly assembly with the second thread 2B of the second container 2. In such a way, the baffle valve 6 can be used to assemble the first container 1 and the second container 2 together. Further, the first thread 2A of the second container 2 is adapted for threadly assembling with the second thread 3B of the temperature unit 3, so as to assemble the temperature unit 3 to the second unit 2.

Solid substance of the beverage is assumed previously provided in the first container 1, and drinking water is previously provided in the second container 2, and supposing that a user desires to serve a hot beverage, the temperature unit 3 can be used to heat the drinking water contained in the second container 2 to a predetermined temperature. In such a way, the heated drinking water can be used to conveniently serve a hot beverage as desired.

The temperature unit 3 preferably includes an electric heater (not shown in the drawings) having a power supply unit electrically coupled to a heat generator and a control interface. The control interface includes keys or a control lever adapted for controlling the heating temperature or heating time, so as to accurately control the temperature of the drinking water contained in the second container as desired.

Preferably, the temperature unit 3 further includes an electric cooling unit (not shown in the drawings) having a power supply unit electrically coupled to a cooling apparatus and a control interface. The control interface includes keys or a control lever adapted for controlling the electric cooling unit to cool down the drinking water contained in the second container to a desired temperature.

As illustrated above, the solid substance of the beverage is previously provided in the first container 1, and drinking water is previously provided in the second container 2, in which the solid substance is positioned on the butterfly valve plate 60. When the knob 61 is rotated, the butterfly valve plate 60 is turned open so that the solid substance falls down to the drinking water contained in the second container 2. In accordance with the previous operation of heating or cooling the drinking water, the user can enjoy a hot or cold beverage as desired.

In accordance with an alternative embodiment, the temperature unit 3 includes a self-heating unit (not shown in the drawings). According to an aspect of the embodiment, the self-heating unit includes ferrous powders, vermiculite, active carbon, and salt. In operation, the vermiculite and active carbon ingredients absorb water content, so as to oxidize the ferrous powders to release heat (4Fe+3O₂→2Fe₂O₃). According to another aspect of the embodiment, the self-heating unit includes an oversaturated sodium acetate solution (i.e., CH₃COONa) and a metallic element provided therein. Since the sodium acetate solution is oversaturated, it is very unstable. When the user twists the metallic element, the oversaturated sodium acetate solution is actuated to crystallize into a relative stable solid. A heat is released associated with the crystallization process, and the released heat is utilized to heat the self-heating unit. The self-heating unit can be repetitively used. When the crystallized stable solid is heated in boiling water, it can be dissolved to recover back to the oversaturated sodium acetate solution again, during which the crystallized stable solid absorbs heat from the boiling water. The recovered oversaturated sodium acetate solution can be used for heating the second container 2 again.

According to a further embodiment of the present invention, the temperature unit 3 includes a thermos kit (not shown in the drawings). The thermos kit includes an ingredient adapted for maintaining the temperature inside the second container 2 less affected by ambient environment. Preferably, the ingredient is stringy propylene glycol adapted for maintaining the drinking water inside the second container 2 warm or cool.

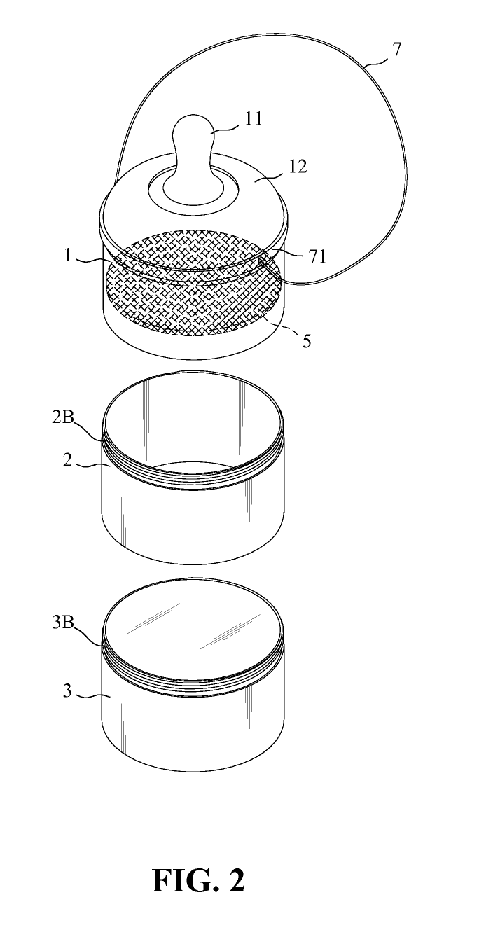

FIG. 2 is an exploded view of the modular container set according to an embodiment of the present invention. Referring to FIG. 2, the first container 1 and the second container 2 are communicable. A sieve 5 is provided in the first container 1, the second container 2, or between the first container 1 and the second container 2. The modular container set of this embodiment is particularly adapted for serving a tea beverage. Tea leave (not shown in the drawings) are previously placed on the sieve 5 inside the first container 1, and drinking water is previously provided inside the second container 2. When the user intends to serve the tea beverage, the temperature unit 3 is used to heat the drinking water contained in the second container 2 to a predetermined temperature. Then, the first container 1 and the second container 3 are placed upside down, so that the heated hot water is mixed with the tea leave to serve the tea beverage. Further, in use, the user may also directly place the body of the modular container set upside down to allow the water flowing through the sieve 5 to enter the first container 1, and after a certain moment, then turn the body of the modular container set back to allow the water flowing back to the second container 2. In such a way, the time of serving the tea beverage can be controlled, so that the tea leave won't be served too long to obtain a tea beverage with a suitable tea concentration. When the user drinks the tea beverage, the tea leave are stopped by the sieve 5 so that the user won't swallow the tea leave with the tea beverage. After drinking, dregs of the tea leave reside on the sieve 5, and are convenient for cleaning.

FIG. 3 illustrates a modular container set according to another embodiment of the present invention. As shown in FIG. 3, the lid 12 further includes a control switch 121. The control switch 121 is preferably a retractable switch having a pushing unit 1211 and a spring unit 1212. The pushing unit 1211 includes a pressing portion 12110, an engagement portion 12111, and a pushing portion 12112. The pressing portion 12110 is configured at a top of the pushing unit 1211, and the pushing portion 12112 is configured at a bottom of the pushing unit 1211. The spring unit 1212 is provided under the engagement portion 12111, and for pushing against the engagement portion 12111 of the pushing unit 1211, so as to maintain the pressing portion 12110 exposing outside the control switch 121.

The first container 1 includes a first opening 100 configured at the bottom of the first container 1 corresponding to the pushing portion 12112 of the pushing unit 1211. A cover 10 is provided for covering and sealing the first opening 100. The cover 10 has one side secured to one side of first opening 100 of the first container 1. The pushing portion 12112 of the pushing unit 1211 is adapted for pushing against the cover 10, so that when the user presses the pressing portion 12110 of the pushing unit 1211 of the control switch 121, the pushing portion 12112 of the pushing unit 1211 pushes the cover 10 away from the first opening 100, such that the first opening 100 is left open and the first container 1 and the second container 2 get communicated. When the user releases the pressing portion 12110 of the pushing unit 1211 of the control switch 121, the spring unit 1212 pushes the engagement portion 12111 of the pushing unit 1211 to recover the pushing unit 1211 back to original position.

The solid substance of the beverage and the drinking water are previously provided in the first container 1 and the second container 2 respectively. When the user desires to serve the beverage, the pressing portion 12110 is pressed down. Correspondingly, the cover 10 is pushed away from the first opening 100 by the pushing portion 12112, such that the solid substance falls down from the first opening 100 of the first container 1 to the drinking water contained in the second container 2. In accordance with the previous operation of heating or cooling the drinking water, the user can enjoy a hot or cold beverage as desired.

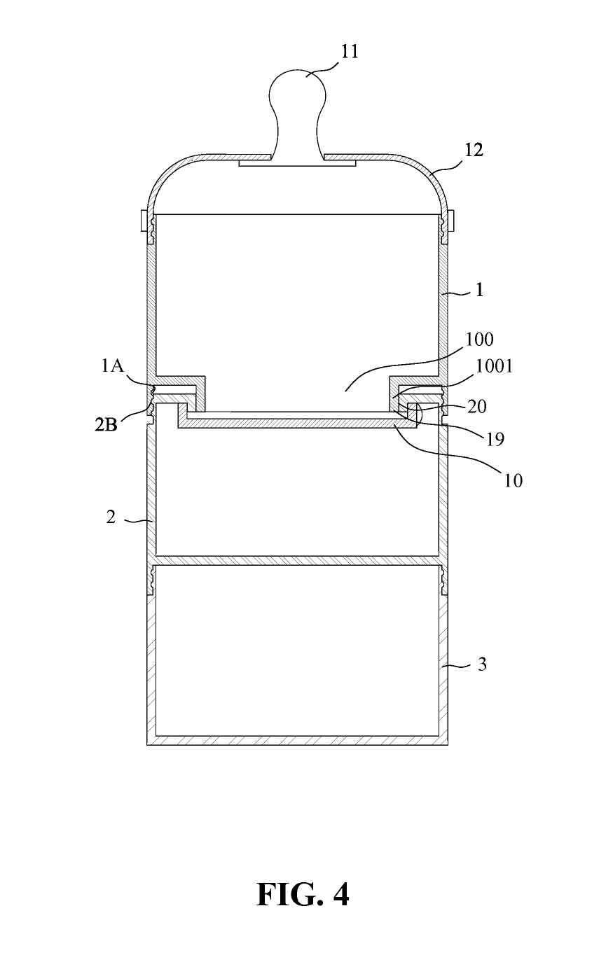

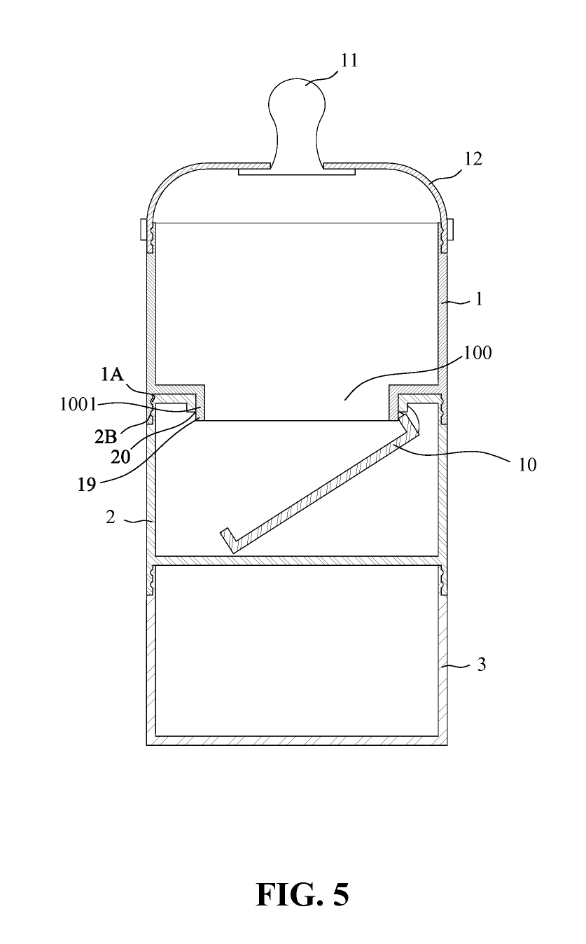

FIG. 4 illustrates a modular container set according to a further embodiment of the present invention. FIG. 5 illustrates the operation of the modular container set according to an embodiment of the present invention.

Referring to FIGS. 4 and 5, according to the embodiment shown in FIGS. 4 and 5, the first container further includes a first opening 100 configured at the bottom portion of the first container 1, and the second container further includes a second opening 20 configured at the upper portion of the second container 2. The first opening 100 is further configured with a protrusion peripheral edge 19 downwardly protruded. The protrusion peripheral edge 19 is adapted for correspondingly coupled inside the second opening 20 of the second container 2. A cover 10 is provided for covering and sealing the second opening 20. The cover 10 has one side secured to one side of second opening 20 of the second container 2. When the first thread 1A of the first container 1 is threadly coupled to the second thread 2B of the second container 2 to a maximum extent, the protrusion peripheral edge 19 exactly protrudes out of the second opening 20 and pushes the cover 10 away from the second opening 20.

The solid substance of the beverage and the drinking water are previously provided in the first container 1 and the second container 2 respectively. When the user desires to serve the beverage, the first container 1 is rotated to threadly couple the first thread 1A of the first container 1 with the second thread 2B of the second container 2 to the maximum extent, such that the cover 10 is pushed away from the second opening 20 by the protrusion peripheral edge 19, such that the solid substance falls down from the first opening 100 of the first container 1 to the drinking water contained in the second container 2. In accordance with the previous operation of heating or cooling the drinking water, the user can enjoy a hot or cold beverage as desired.

The modular container set according to the present invention has many advantages. For example, the modular container set is convenient for cleaning, and can completely remain the solid substance away from the drinking water. The serving operation is simple and convenient. The first container 1 and the second container 2 are easy to be assembled.

According to a further embodiment of the present invention, the modular container set further includes a strap 7 secured to the first container 1 or the second container 2 via a securing member 71.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A modular container set, comprising:
a first container, comprising a lid, wherein the lid is configured with a drinking unit;
a second container, wherein when an upper portion of the second container is assembled to a bottom portion of the first container, the first container is coupled to communicate with the second container;
a temperature unit, coupled to a bottom portion of the second container, wherein the temperature unit is adapted for heating, cooling the second container, or maintaining the second container warm or cool; and
a baffle valve, provided between the first container and the second container.

2. The modular container set as claimed in claim 1, wherein each of the bottom portion of the first container, a bottom portion of the second container, and a bottom portion of the baffle valve is configured with a first thread, and each of the upper portion of the second container, an upper portion of the baffle valve, and an upper portion of the temperature unit is configured with a second thread, wherein the first thread is adapted for threadly coupling with the second thread.

3. The modular container set as claimed in claim 1, wherein the temperature unit is an electric heater having a power supply unit electrically coupled to a heat generator and a control interface, wherein the control interface comprises keys or a control lever adapted for controlling a heating temperature or a heating time, so as to accurately control a temperature of the drinking water contained in the second container.

4. The modular container set as claimed in claim 1, wherein the temperature unit is an electric cooling unit having a power supply unit electrically coupled to a cooling apparatus and a control interface.

5. The modular container set as claimed in claim 1, wherein the lid of the first container comprises a retractable switch having a pushing unit and a spring unit, wherein the pushing unit comprises a pressing portion configured at a top of the pushing unit, an engagement portion, and a pushing portion configured at a bottom of the pushing unit, wherein the spring unit is provided under the engagement portion, and is adapted for pushing against the engagement portion of the pushing unit, so as to maintain the pressing portion exposing outside the control switch, wherein a first opening is configured at the bottom portion of the first container corresponding to the pushing portion of the pushing unit, the first opening being provided with a cover for covering and sealing the first opening, the cover having one side secured to one side of the first container, wherein the pushing portion of the pushing unit is adapted for pushing the cover away from the first opening.

6. The modular container set as claimed in claim 1, wherein a first opening is configured at the bottom portion of the first container, the first opening being configured with a protrusion peripheral edge downwardly protruded and adapted for being sheathed inside a second opening of the second container, wherein when the first thread of the first container is threadly coupled to the second thread of the second container to a maximum extent, the protrusion peripheral edge protrudes out of the second opening and pushes the cover away from the second opening.

7. A modular container set, comprising:
a first container, comprising a lid and a sieve disposed inside the first container, wherein the lid is configured with a drinking unit;
a second container, wherein when an upper portion of the second container is assembled to a bottom portion of the first container, the first container is coupled to communicate with the second container; and
a temperature unit, coupled to a bottom portion of the second container, wherein the temperature unit is adapted for heating, cooling the second container, or maintaining the second container warm or cool.

8. The modular container set as claimed in claim 7, wherein each of the bottom portion of the first container, and a bottom portion of the second container is configured with a first thread, and each of the upper portion of the second container, and an upper portion of the temperature unit is configured with a second thread, wherein the first thread is adapted for threadly coupling with the second thread.

9. The modular container set as claimed in claim 7, wherein the temperature unit is an electric heater having a power supply unit electrically coupled to a heat generator and a control interface, wherein the control interface comprises keys or a control lever adapted for controlling a heating temperature or a heating time, so as to accurately control a temperature of the drinking water contained in the second container.

10. The modular container set as claimed in claim 7, wherein the temperature unit is an electric cooling unit having a power supply unit electrically coupled to a cooling apparatus and a control interface.

11. The modular container set as claimed in claim 7, wherein a first opening is configured at the bottom portion of the first container, the first opening being configured with a protrusion peripheral edge downwardly protruded and adapted for being sheathed inside a second opening of the second container, wherein when the first thread of the first container is threadly coupled to the second thread of the second container to a maximum extent, the protrusion peripheral edge protrudes out of the second opening and pushes the cover away from the second opening.
